(19) United States
(12) Patent Application Publication
(10) Pub. No.: US 2003/0105712 A1
(43) Pub. Date: Jun. 5, 2003

(54) Messaging system and method

(76) Inventor: Gerhard Bodensohn, Seligenstadt (DE)

Correspondence Address: HENRY M FEIEREISEN, 350 FIFTH AVENUE, SUITE 3220, NEW YORK, NY, 10118, US

(21) Appl. No.: 10/301,116

(22) Filed: Nov. 21, 2002

Related U.S. Application Data
(60) Provisional application No. 60/334,559, filed on Nov. 30, 2001.

(51) Int. Cl. G06F 17/60

(52) U.S. Cl. 705/40

(57) ABSTRACT

The invention provides a system and method for a for-fee messaging and transaction service to be conducted over a network, such as the Internet. The disclosed system and method makes it possible to transmit email, files, documents and other information of value to a recipient, wherein the recipient only has access to the respective information after payment has been received by a server.

### CROSS-REFERENCES TO RELATED APPLICATIONS

This application claims the benefit of prior filed provisional application, Appl. No. 60/334,559, filed Nov. 30, 2001, pursuant to 35 U.S.C. 119(e), the disclosure of which is incorporated herein by reference.

### BACKGROUND OF THE INVENTION

The present invention relates to methods and systems for sending and receiving information over a network, and more particularly to methods and systems for network services where a fee has to be paid by either the sender or the recipient of the information.

The exchange of information over networks, in particular over the Internet, has experienced an explosive growth over the past decade. More and more information is presently carried over the Internet, from simple text messages to large documents and files containing video and audio, as well as sensitive information and financial data, which can additionally be encrypted. For access to a network, a user typically establishes an account with a service provider, such as AOL or the Microsoft Network (MSN). A user can also be connected with other users via an intranet or another local (LAN) or wide-area (WAN) network, such as a network used in larger organizations, and is then connected to the Internet.

Widely used over the Internet are messaging tools, such as email. In most cases, transmitting email from one user to another user is free, requiring only a subscription to the service provider for Internet access. However, free email service tends to be unregulated, giving rise to undesirable spam mail and lack of security, unless security is implemented on the user end, for example, by a suitable filter or by encrypting the messages.

It would therefore be desirable and advantageous to provide an email service between properly identified and/or registered users that eliminates the aforedescribed disadvantages.

### SUMMARY OF THE INVENTION

The invention is directed to methods and systems for network services where a fee has to be paid by either the sender or the recipient of information before the information, such as an email, a file and the like, is released to the recipient.

According to one aspect of the invention, a method for delivering a message between a sender and a recipient over a network is disclosed. The sender transmits a message request to a server, and the server compares payment authorization for transmission of the message associated with the message request to the recipient. The server transmits the message to the recipient if payment is authorized.

According to another aspect of the invention, a server for managing message delivery over a network after payment of a transaction fee includes an input module adapted to identify at least metadata of the message, a control module that identifies registration information of a sender or recipient of the message, an administration module that links the registration information with payment information of at least one of the sender and recipient, a storage device for storing the message at least temporarily before a payment is authorized, and a network connection for communication with the sender and recipient.

According to yet another aspect of the invention, a message transaction system for delivering a message over a network after payment of a transaction fee is disclosed. The system includes a server; a first message client connected to the server via the network, wherein the first message client sends the message; and a second message client connected to the server via the network, wherein the second message client is an intended recipient of the message. The server includes an input module adapted to identify at least metadata of the message, a control module that identifies registration information of at least one of the first and second clients, an administration module that links the registration information with payment information of the at least one first and second clients, and a storage device for storing the message at least temporarily before a payment is authorized based on said registration information and payment information.

Embodiments of the invention can include one or more of the following features. Payment can be authorized by comparing metadata in the message request with registration information residing on the server or a component of the server, such as the server database. Metadata of the message can be stored separate from payload data of the message. The server transmits the message to the recipient if at least one of the sender and recipient is registered with the server and has authorized payment for transmitting the message. If payment is not authorized, at least one of the sender and recipient can be offered to register with the server and open an account for payment authorization. However, the server holds the message if payment is not authorized and may purge the message after a predetermined time has elapsed. The network can be the Internet, an intranet, a LAN or a WAN. The messages can include email, data files, audio files, image files and the like.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 depicts schematically the structure of a system according to the invention that employs a computer network for exchanging information over a network;

FIG. 2 depicts schematically various application programs running on a server in the system of FIG. 1; and

FIG. 3 is an exemplary schematic flow diagram depicting a process of a for-fee email service.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way.

To provide an overall understanding of the invention, certain illustrative embodiments will now be described, including a system and a method for transmitting for-fee email messages and providing other for-fee services over the Internet. However, it will be understood by one of ordinary skill in the art that the systems and methods described herein can be adapted and modified for other suitable applications and that such other additions and modifications will not depart from the scope hereof.

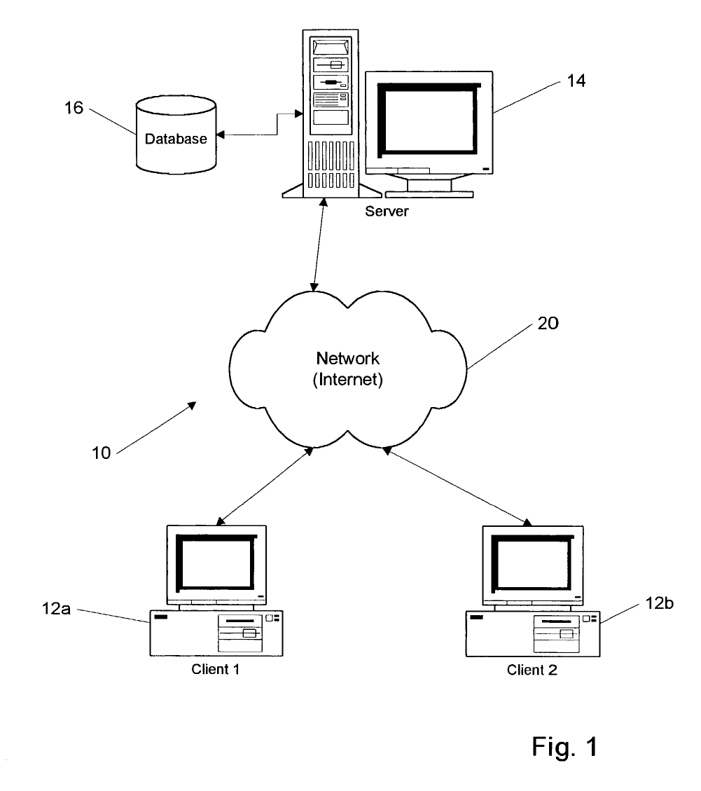

FIG. 1 depicts one embodiment of a system 10 according to the invention for for-fee services and/or transactions conducted over the Internet. Specifically, FIG. 1 illustrates a system 10 wherein a plurality of subscriber systems 12a, 12b connect through a network 20 to the server 14. The server 14 connects to a database 16 maintained by the server 14, which can be a proprietary database. The elements of the system 10 can include commercially available systems that have been arranged and modified to act as a system according to the invention, which allows a subscriber to carry out for-fee services and/or transactions, and optionally generates records of such services and/or transactions. The exemplary system 10 of FIG. 1 employs the Internet to allow a subscriber at a remote client, such as one of the subscriber systems 12a, 12b, to access a central server, the depicted central server 14, to login to an account maintained by that server, and to employ the services provided on that account to perform the for-fee services and/or transactions.

For example, the server 14 can present the subscriber with an HTML page that acts as a user interface. This user interface can present to the subscriber a set of controls for performing the for-fee services and/or transactions. For example, a control, typically a button on a web page, can direct the system to a user module that contains user information.

For the depicted system 10, the client systems 12a, 12b can be any suitable computer system, such as a PC workstation, a handheld computing device, a wireless communication device, or any other such device, equipped with a network client capable of accessing a network server and interacting with the server to exchange information with the server. In one embodiment, the network client is a web client, such as a web browser that can include the Netscape web browser, the Microsoft Internet explorer web browser, the Lynx web browser, or a proprietary web browser, or web client that allows the user to exchange data with a web server, and ftp server, a gopher server, or some other type of network server. Optionally, the client and the server rely on an unsecured communication path, such as the Internet, for accessing services on the remote server. To add security to such a communication path, the client and the server can employ a security system, such as any of the conventional security systems that have been developed to provide to the remote user a secured channel for transmitting data over the Internet. One such system is the Netscape secured socket layer (SSL) security mechanism that provides to a remote user a trusted path between a conventional web browser program and a web server. Therefore, optionally and preferably, the client systems 12a, 12b and the server system 14 have built-in 128 bit SSL capability and can establish an SSL communication channel between the clients 12a, 12b and the server 14. Other security systems can be employed, such as those described in Bruce Schneir, Applied Crytpography (Addison-Wesley 1996). For purpose of illustration, the systems described herein, including the system 10 depicted in FIG. 1 will be understood to employ a public channel, such as an Internet connection through an ISP or any suitable connection, to connect the subscriber systems 12a, 12b and the server 14.

The server 14 may be supported by a commercially available server platform such as a Sun Sparc™ system running a version of the Unix operating system and running a server capable of connecting with, or exchanging data with, one of the subscriber systems 12a, 12b. In the embodiment of FIG. 1, the server 14 includes a web server, such as the Apache web server or any other suitable web server. The web server component of the server 14 acts to listen for requests from subscriber systems 12a, 12b, for example, an email message sent by the subscriber, and in response to such a request, resolves the request to identify a filename, script, dynamically generated data that can be associated with that request and/or subscriber, for example, payment information, and then forwards the email data sent by one of the subscribers 12a, 12b to the addressed subscriber system 12b, 12a. The operation of the web server component of server 14 can be understood more fully from Laurie et al., Apache The Definitive Guide, O'Reilly Press (1997). The server 14 may also include components that extend its operation to accomplish the for-fee services and/or transactions described herein, and the architecture of the server 14 may vary according to the application. For example, the web server may have built in extensions, typically referred to as modules and described in more detail below, to allow the server 14 to perform operations that facilitate the for-fee services and/or transactions desired by a subscriber, or the web server may have access to a directory of executable files, each of which files may be employed for performing the operations, or parts of the operations, that implement the for-fee services and/or transactions of the subscriber. Thus it will be understood that the server 14 may act as a for-fee service and/or transaction server according to the invention that configures the workstation hardware supporting the server 14 to act as a system according to the invention.

The server 14 may couple to a database 16 that stores information representative of a subscriber's account, including information about the email metadata and information regarding the subscriber's account, such as tasks that have already been executed and tasks still to be executed, including password, user account, user privileges and similar information. The depicted database 16 may comprise any suitable database system, including the commercially available Microsoft Access database, and can be a local or distributed database system. The design and development of database systems suitable for use with the system 10, follow from principles known in the art, including those described in McGovern et al., A Guide To Sybase and SQL Server, Addison-Wesley (1993). The database 16 can be supported by any suitable persistent data memory, such as a hard disk drive, RAID system, tape drive system, floppy diskette, or any other suitable system. The system 10 depicted in FIG. 1 is shown as having a database device 16 that is separate from the server station platform 14; however, it will be understood by those of ordinary skill in the art that in other embodiments the database device 16 can be integrated into the server 14.

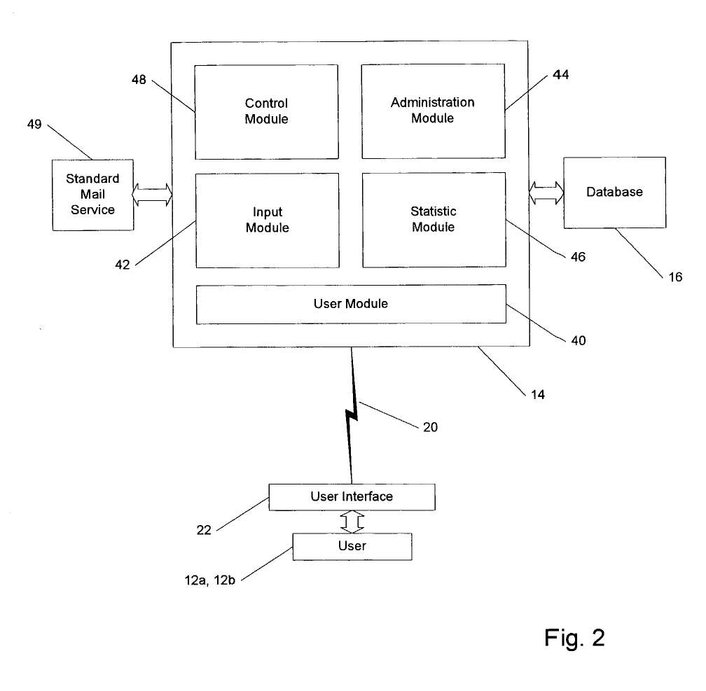

FIG. 2 provides a functional block diagram of the server 14 for performing for-fee services and/or transactions and further depicts the various modules of the server 14 to perform a for-fee service and/or transaction between the subscribers 12a and 12b. Specifically, FIG. 2 depicts a diagram wherein a subscriber 12a employs a user interface 22 to provide user input to the server 14. As can be seen from FIG. 2, the server 14 acts as middleware that coordinates the operations between the subscribers 12a and 12b. Only one exemplary user 12a, 12b is shown to simplify the drawing. Specifically, the server 14 is shown as a functional block diagram that includes a user module 40, an input module 42, an administration module 44, a statistics module 46 and a control module 48. The server 14 is also shown as being connected to the database 16 and to standard mail server application software 49.

The system has installed an email input module which forwards the received email messages to an application program residing on server. This occurs, as is normal for standard-email servers, according to standard configurable rules and options. Transfer to the application program is accomplished, for example, by reading and/or writing to a standard input/output device or via a temporary file.

As seen from FIG. 2, the user 12a, 12b inputs transaction information, such as an email message, that can include metadata representing certain keywords of the matter, for example, sender, recipient and routing information, as well as references to contents and the transactions to be performed. The email can also include additional content, as well as files that include text, images video, audio, etc. The user interface 22 can be a standard Web page, as discussed above, interfaced via a communication link 24, such as the Internet depicted in FIG. 1, to the server 14 in particular the user module 40.

With the present invention being directed to for-fee services and/or transactions, the user module 40 at the server 14 accepts user input, for example, to open an account, to transact business using this account or to cancel this account. The user is able to enter/change personal data as well as existing email addresses and their configuration. The user can also review with the user module 40 the actual account balance, personal statistics (downloaded from the database 16), and the user can make or receive payment. The user module 40 can be implemented as a dynamic Web page that processes information of the database 16, or can be a separate application program running on the computer of the client/subscriber 12a, 12b and processing the data packets requested from the server 14 via the Internet 20. The user module 40 and the user interface 22 can hence optionally be combined in the user interface 22.

To gain access to the server/user module 40, the subscriber typically has to enter a user name/password combination or similar keys. Moreover, the user module 40 can be used to request from the user information about the currency to be used or the payment method, and/or to authorize payment. The user module 40 can also authorize certain actions to be taken relating to, for example, information contained in the database 16.

The server 14 software processes the received information and can use in this process also standard mail server application programs 49. Additional information extracted from the user message can be used for additional purposes using suitable software, such as standard Web mailer software or POP/IMAP server software known in the art.

The input module 42 uses the header information of the email to determine the sender and the recipient of the email. It may be possible to derive further keywords from the content or header information of the email. These key words will be referred to as metadata. The metadata are then stored in a waiting list in the database 16, whereas the email content itself can be stored separately in the database 16 or as a file, with an ID being associated with the stored email. Certain types of email messages, such as email messages identified by the input module 42 as control email messages, are recognized by the input module and can be stored separately in the database.

The control module 48 monitors, either automatically or in response to a notification, the stored metadata. The control module 48 is a separate application program that has access to the database and regularly queries metadata or reacts to certain events of other programs (for example, call routines for exported functions or via a separate control socket). It will be understood by those skilled in the art that the control module 48 can also be composed of several programs which share the aforedescribed tasks or execute these task in parallel.

The control module 48 processes the information as follows: new metadata are linked by the control module 48 via a their respective email address with existing user information that is stored, for example, in the database 16 (database query). The email message can then be indexed based on the received metadata and the linked user data, and necessary actions are stored with the metadata. One possible action is, for example, a payment transaction. A recipient or sender has to be registered in the system database only if he expects to receive a payment or make a payment in connection with the service and/transaction provided, such as the email transmission. If an email address is not registered and can therefore not be found in the database and associated with the message, but is still needed for executing an action, then the sender of that email is informed about this event, for example, by receiving a message from a status service (not shown).

The control module 48 checks processed metadata to determine if certain actions of or for the involved users can be processed automatically. If this is the case, then the control module 48 executes this action by initiating a transaction in the database 16. The change in status after the execution of this transaction is stored with the metadata. On the other hand, if actions cannot be executed automatically, then the control module recognizes this event and informs the person (for instance an administrator charged to perform these transactions) to execute this transaction manually. That person can also be notified after a certain time has elapsed or after certain actions have been taken. For this purpose, the control module 48 can use certain software, such as SMS Gateway or Emailer. The status check can be performed by other services, for example implemented as a subprogram.

After all required actions for a specified message have been performed this message can be transmitted to the recipient. The control module 48 determines from the metadata and linked user information of the recipient the actual target address of the message, sends the message with a suitable subprogram, removes the message from a waiting list stored, for example, in the database 16, and archives the entire message, portions thereof or only the metadata for subsequent processing. Likewise, the messages that remain on the waiting list past a certain predetermined time, are also sorted out and archived (equivalent to emptying a cache).

The database 16 includes the following information that can be stored in files or database regions that can be linked with one another:

All metadata of the email, as well as type, status and any required steps.

Previously executed actions, such as sent messages, can be stored in a long file or directly noted in the metadata set.

User data of registered users, including one or several email addresses, personal data, such as address, telephone number, and a transaction type associated with the information to be used, for example, by the control module. The transaction type can determine the fees charged for the for-fee email service, automatic billing or forwarding addresses.

The database can also include account information for each user, such as payments, receipts, received and sent emails. Membership fees can also be paid in this way, wherein accounting can be limited to invoicing for software and direct value-added services. The account information can further include credit card information, including authorization numbers that may be encrypted, and a maximum account balance limit.

The statistics module 46 is used optionally for evaluation, monitoring and analysis of the software running in the various modules of server 14. For example, statistical data derived by the statistics module 46 can be used for surveys and/or marketing purposes.

The administration module 44 is intended to aid an administrator of the software running on server 14 to configure parameters of the software and, if necessary, to review or change user data or to deny users access to the server 14. The administration module 44 can also be used for accounting purposes, such as to prepare standardized invoices and/or payment notices, or to export the data to an online banking-enabled format.

All modules cooperate through the common shared database 16 and thereby coordinate their actions.

It is an important aspect of the invention that the database 16 and the administration module 44 are closely linked with the server 14. In other words, the mail server operates under the control of the database 16 and the administration module 44. It is another aspect of the invention, that a transmission of messages, such as email, is linked with a payment system, so that messages are not delivered directly to a recipient, but are first stored in the database 16 of the server 14 until payment is received, either from the sender when the message is transmitted, or from the recipient who has to be properly authorized. Payment can be administered by the database 16 or by the cooperating administration module 44, as described above.

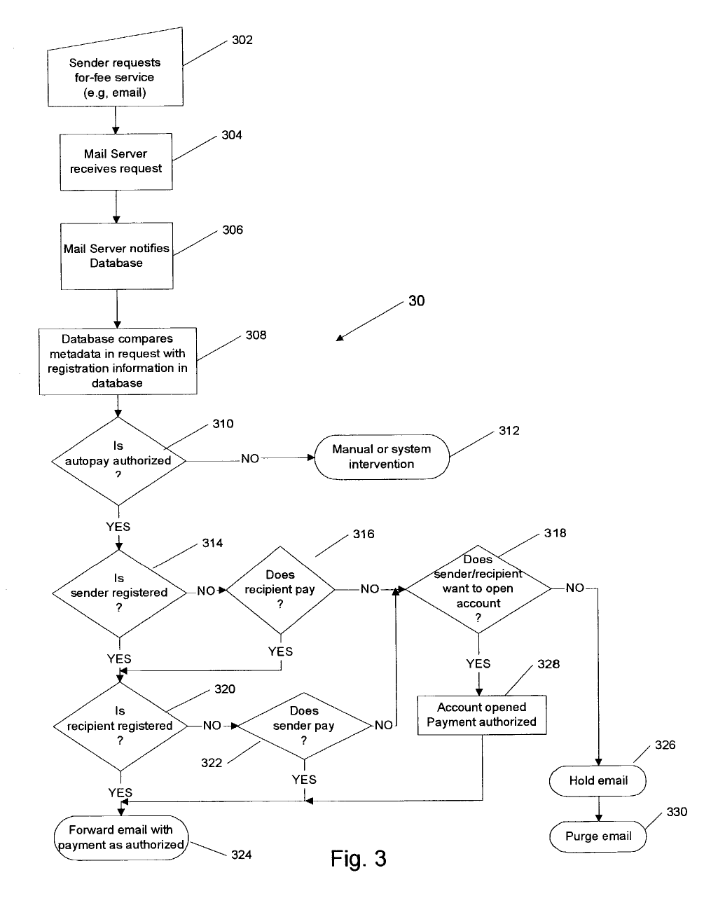

FIG. 3 illustrates a process flow 30 of email transmission using the for-fee system of the invention. In the process 30, a sender, such one of the subscribers 12a, 12b, requests a for-fee service, for example transmission of an email message, step 302. In step 304, the mail server 14 receives the request and notifies the database 16, step 306. The database 16 compares the information received with the email, for example the metadata of the email, with registration information contained in the database, step 308. In step 310, it is checked if an autopay feature is enabled. If the autopay feature is not authorized for either party, i.e. the sender or the recipient, then manual or another form of system intervention is requested, step 312. System intervention can include, for example, web-based registration and payment authorization by the sender, for example, via the sender's credit card or bank account. Conversely, if the autopay feature has been enabled, it is checked in the following steps, if the sender or the recipient is paying or has agreed to pay for transmitting the message. If autopay is enabled, it is checked in step 314 if the sender is registered with the database based on the sender/metadata and registration information. If the sender is not registered, then it is checked in step 316 if the recipient is responsible for payment . If it is determined in step 316 that the recipient does not want to be responsible for payment, then the sender of the original email is offered an opportunity, for example by an email message from the server 14, to open an account with the server 14, step 318. If the sender opens an account and authorizes payment, step 328, then the process goes to step 324, and the email is sent to the recipient. Conversely, if it is determined in step 316 that the recipient is responsible for payment, then step 320 checks if the recipient is registered with the server 14, step 320. If it is determined in step 320 that the recipient is registered, then the recipient is billed and the email is forwarded to the recipient with the authorized payment option, step 324. However, if it is determined in steps 320 that the recipient is not registered, then steps 322 checks if the sender gave authorization for payment. If it is determined in step 322 that the sender did not authorize payment, then the recipient of the email is, like the sender before, offered an opportunity, for example by an email message from the server 14, to open an account with the server 14, step 318. If the recipient opens an account and authorizes payment, step 328, then the process goes to step 324, and the email is sent to the recipient. Conversely, if neither the sender nor the recipient authorized payment or agreed to open an account, then the process 30 goes to step 326 and the email is held, for example, at the server. The held email is removed from the system either by the administrator or after expiration of a preset time period, step 330.

The system is designed so that a user having access to the Internet and running a conventional email or messaging application program can immediately participate in the for-fee email and/or message exchange. The user can either open a for-fee email account, i.e., an account for which a fee is required, or can send email to a for-fee account or receive email from a for-fee account. As mentioned above, the email is just one example of a message or information exchange and is intended to include transmission of any file type, such as a video, audio, graphic, text, etc. Unlike conventional email where the message is sent directly to the recipient, the email in the present invention is retained by the server until payment is received from either the sender or the recipient.

Various modifications of the present arrangement can be envisioned. For example, the system and method of the invention can be used for a for-fee subscription service, such as document or music exchange, where in a file can be sent to an email portal, such as yahoo.com or another Web portal, and transmitted to a recipient upon payment. Likewise, the system could be used for financial transaction wherein a sender and a recipient maintain accounts with the same institution (server), with the sender authorizing payment and the recipient receiving payment. The authenticity of the user can be verified through the mail address, a PIN or a secret keyword, a fixed IP address or a certificate, a return email, or another method known in the art for user verification. Opening a user account can be combined with a request for authentication.

An current status of pending email and statistical data can be queried by the user via a Web interface, as described above. Other interfaces can be provided for different payment methods, such as credit cards, telephone invoices, debit accounts, or any other payment or micro-payment form. The account can have a certain stored amount, similar to cash cards. The system can be easily integrated with other Web-based communities or Internet email services to provide for-fee services and transactions that have so far been executed manually or by telephone or fax.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method for delivering a message between a sender and a recipient over a network, comprising the steps of:
the sender transmitting a message request to a server,
the server comparing payment authorization for transmission of the message associated with the message request to the recipient, and
the server transmitting the message to the recipient if payment is authorized.

2. The method of claim 1, wherein comparing payment authorization includes comparing metadata in the message request with registration information at the server.

3. The method of claim 2, wherein the registration information is stored in a database associated with the server.

4. The method of claim 2, wherein the server transmits the message if at least one of the sender and recipient is registered with the server and has authorized payment for transmitting the message.

5. The method of claim 2, wherein if payment is not authorized, at least one of the sender and recipient is offered to register with the server and open an account for payment authorization.

6. The method of claim 1, wherein the server holds the message if payment is not authorized.

7. The method of claim 1, wherein if payment is not authorized, the server holds the message for a predetermined time before purging the message.

8. A server for managing message delivery over a network after payment of a transaction fee, comprising:
an input module adapted to identify at least metadata of the message,
a control module that identifies registration information of a sender or recipient of the message,
an administration module that links the registration information with payment information of at least one of the sender and recipient,
a storage device for storing the message at least temporarily before a payment is authorized, and
a network connection for communication with the sender and recipient.

9. The server of claim 8, wherein the network connection is a connection with the Internet, an intranet, a LAN or a WAN.

10. The server of claim 8, wherein the storage device further stores at least one of the registration information and payment information.

11. The server of claim 8, wherein the storage device stores metadata of the message separate from payload data of the message.

12. A message transaction system for delivering a message over a network after payment of a transaction fee, comprising
a server;
a first message client connected to the server via the network, said first message client sending the message;
a second message client connected to the server via the network, said second message client being an intended recipient of the message;
the server comprising
an input module adapted to identify at least metadata of the message,
a control module that identifies registration information of at least one of the first and second clients,
an administration module that links the registration information with payment information of the at least one first and second clients, and
a storage device for storing the message at least temporarily before a payment is authorized based on said registration information and payment information.

13. The system of claim 12, wherein the payment is authorized based on the metadata in the message.

14. The system of claim 12, wherein the server transmits the message to the second message client if at least one of the first and second message clients is registered with the server and has authorized payment for transmitting the message.

15. The system of claim 12, wherein the network is selected from the group consisting of the Internet, an intranet, a LAN or a WAN.

16. The system of claim 12, wherein the message is selected from the group consisting of email, data files, audio files, and image files.
